(19) United States
(12) Patent Application Publication
(10) Pub. No.: US 2015/0087389 A1
(43) Pub. Date: Mar. 26, 2015

(54) SYSTEM AND METHOD OF PROVIDING SYSTEM-BASED BONUSING AWARDS IN A CASINO ENVIRONMENT

(71) Applicant: Konami Gaming, Inc., Las Vegas, NV (US)

(72) Inventors: Michael Ratner, Las Vegas, NV (US); Stephen Walther, Las Vegas, NV (US)

(21) Appl. No.: 14/485,476

(22) Filed: Sep. 12, 2014

Related U.S. Application Data
(60) Provisional application No. 61/880,734, filed on Sep. 20, 2013.

(51) Int. Cl. G07F 17/34; G07F 17/32

(52) U.S. Cl. CPC G07F 17/34; G07F 17/3213
USPC 463/20

(57) ABSTRACT

A system for providing an award to a plurality of players is described herein. The system includes a plurality of gaming devices and a system controller coupled to each of the gaming devices. The system controller initiates a bonus game on a set of gaming devices. Each of the gaming devices included in the set is associated with a qualified player. The system controller selects a bonus game symbol for each qualified player from a predefined set of bonus game symbols and associates each selected bonus game symbol with the corresponding qualified player. The system controller also randomly selects a winning bonus game symbol from the predefined set of bonus game symbols, determines a number of winning qualified players associated with the winning bonus game symbol, and provides a bonus award to each of the winning qualified players.

### CROSS-REFERENCE TO RELATED APPLICATION

This application claims priority to U.S. Provisional Application No. 61/880,734, filed Sep. 20, 2013, the disclosure of which is hereby incorporated by reference in their entirety.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The invention generally relates to systems and methods for providing a system based bonusing award in a casino environment.

### BACKGROUND OF THE INVENTION

Gaming machines, such as slot machines, are a cornerstone of the gaming industry. Many gaming machines are connected through system-based player tracking system in order to manage a player's game play history and provide additional bonus incentives in response to continued game play by the player. It is through these system-based player tracking systems that a gaming property can offer additional incentives across all games that are available to a player.

At least some known gaming systems provide bonus awards to players based on associated game play. The bonus awards may include additional gaming credits and/or non-gaming services such as complimentary food and beverages. However, these known systems provide the bonus awards to each player based on individual game play. Over time, a player may become frustrated with known gaming systems because of the amount of game play required to receive an award. Accordingly, new features are necessary to appeal to player interest and enhance excitement in order to entice longer play and increased profitability. The present invention is aimed at one or more of the problems identified above.

### BRIEF SUMMARY OF INVENTION

In one aspect of the present invention, a floor-wide bonus game (or FBG) is provided. will be referred to as FBG. The bonus game may be provided or delivered by a Casino Management System or player tracking system. In general, the floor-wide bonus game may be provided to qualified players only.

In another aspect of the present invention, the FBG is based on a multiple round elimination format where qualified players will pick a character or an object with the goal of being the sole survivor. Qualified players are prompted to make a selection of a character or an object and the FBG will play through a series of elimination rounds that employ movies showing the actual elimination event. As the game progresses through the various rounds, certain players will be eliminated and other players will progress through to the next round. Operators can select between 2-4 elimination rounds with the resulting outcome of the game being a single survivor. All players that selected the surviving character or object will share in a defined pool of prize money. The prize money will be distributed to the players as non-cashable bonus play cash.

In one aspect of the present invention, a system for providing an award to a plurality of players is provided. The system includes a plurality of gaming devices and a system controller coupled to each of the gaming devices. Each of the gaming devices includes a display device. The system controller configured to initiate a bonus game and display the bonus game on a set of gaming devices. Each gaming device included in the set of gaming devices is associated with a qualified player. The bonus game includes a predefined set of bonus game symbols. The system controller selects a bonus game symbol for each qualified player from the predefined set of bonus game symbols and associates each selected bonus game symbol with the corresponding qualified player. The system controller also randomly selects a winning bonus game symbol from the predefined set of bonus game symbols, determines a number of winning qualified players associated with the winning bonus game symbol, and provides a bonus award to each of the winning qualified players.

In another aspect of the present invention, a method of providing an award to a plurality of players is provided. The method includes the steps of initiating a bonus game being displayed on a plurality of gaming devices. Each of the plurality of gaming devices is associated with a qualified player. The bonus game includes a predefined set of bonus game symbols. The method includes selecting a bonus game symbol for each qualified player from the predefined set of bonus game symbols and associating each selected bonus game symbol with the corresponding qualified player. The method also includes randomly selecting a winning bonus game symbol from the predefined set of bonus game symbols, determining a number of winning qualified players associated with the winning bonus game symbol, and providing a bonus award to each of the winning qualified players.

In yet another aspect of the present invention, one or more non-transitory computer-readable storage media, having computer-executable instructions embodied thereon, is provided. The computer-executable instructions cause a processor to initiate a bonus game and display the bonus game on a set of gaming devices. Each gaming device included in the set of gaming devices being associated with a qualified player. The bonus game includes a predefined set of bonus game symbols. The processor selects a bonus game symbol for each qualified player from the predefined set of bonus game symbols and associates each selected bonus game symbol with the corresponding qualified player. The processor also randomly selects a winning bonus game symbol from the predefined set of bonus game symbols, determines a number of winning qualified players associated with the winning bonus game symbol, and provides a bonus award to each of the winning qualified players.

### BRIEF DESCRIPTION OF THE DRAWINGS

Other advantages of the present invention will be readily appreciated as the same becomes better understood by reference to the following detailed description when considered in connection with the accompanying drawings:

FIG. 1 is a diagram of a system for use in providing a bonus award to players, according to an embodiment of the present invention;

FIG. 2 is a perspective view of an exemplary gaming device that may be used with the system shown in FIG. 1;

FIG. 3 is a schematic representation of a gaming controller that may be used with the gaming device shown in FIG. 1, according to an embodiment of the present invention;

FIG. 4. is an exemplary entertaining graphical display of a game play screen including a slot-type game that may be displayed on the gaming device shown in FIG. 2.

FIG. 5 is a block diagram of the system shown in FIG. 1, according to an embodiment of the present invention;

FIG. 6 is a block diagram of a portion of an exemplary player tracking module that may be used with the system shown in FIG. 1, according to an embodiment of the present invention;

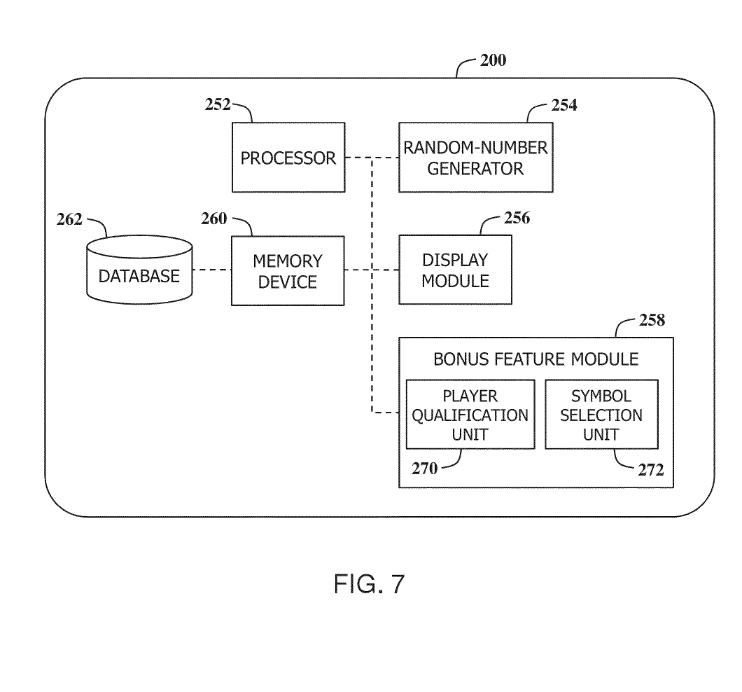

FIG. 7 is a schematic representation of a system controller that may be used with the system shown in FIG. 1, according to an embodiment of the present invention;

FIG. 8 is a flowchart of a method that may be used for providing an award to a plurality of players, according to an embodiment of the present invention.

FIGS. 9 and 10 are exemplary entertaining graphical displays of a game screen including a bonus feature game that may be displayed by the system shown in FIG. 1 during the method shown in FIG. 8, according to an embodiment of the present invention.

Corresponding reference characters indicate corresponding parts throughout the drawings.

### DETAILED DESCRIPTION OF THE INVENTION

With reference to the drawings and in operation, the present invention overcomes at least some of the disadvantages of known gaming systems by providing a system which awards a plurality of players a player tracking award in a floor-wide bonusing game. Moreover, the gaming system initiates a bonus game feature that allows a plurality of players to select bonus game symbols, conducts one or more elimination rounds with the selected bonus game symbols to determine a winning symbol, and provides an award to each player that selected the winning symbol. In addition, the system provides the bonus feature game including a set of qualification criteria and qualifies each participating player based on the associated set of qualification criteria. By providing a system that provides an award to multiple players and that limits participation in the game to qualified players, the probability of a qualified player receiving an bonus award, the player's expectation for achieving an bonus award is increased, and the incentive to players to obtain a qualified players status are increased. Thus, the amount of time that patrons play games associated with a gaming establishment is thereby increased.

A selected embodiment of the present invention will now be explained with reference to the drawings. It will be apparent to those skilled in the art from this disclosure that the following description of the embodiment of the present invention is provided for illustration only and not for the purpose of limiting the invention as defined by the appended claims and their equivalents.

### System Generally

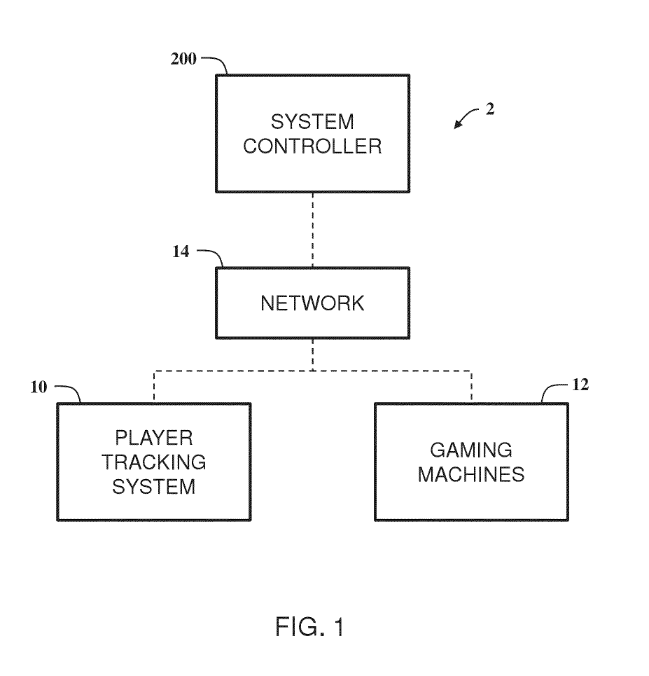

FIG. 1 is a schematic view of an exemplary entertainment and monitoring system 2. In the illustrated embodiment the entertainment and monitoring system 2 includes a system controller 200, a player tracking system 10, and one or more gaming devices 12. The system controller 200, player tracking system 10, and gaming devices 12 are each coupled in communication via a network 14 for communication between the system controller 200, the player tracking system 10, and the gaming devices 12. In the illustrated embodiment, the system controller 200 includes various programs for use in executing and providing various services with the player tracking system 10 and the gaming devices 12 and controlling various operations of the player tracking system 10 and the gaming devices 12.

In one embodiment, at least one of the gaming devices 12 is a video gaming machine. In another embodiment, the at least one gaming device 12 may include a personal computer, laptop, cell phone, smartphone, tablet computer, personal data assistant, and/or any suitable computing device that enables a player to connect to the network 14.

In the illustrated embodiment, the network 14 comprises a local area network (LAN). Alternatively, the network 14 may also comprise alternate modes of digital communication, for example, an Internet link, an intranet, a WAN, dial-in-connections, cable modems, wireless modems, and/or ISDN lines. In one embodiment, the gaming device 10 may include a gaming machine installed in a casino. The system 2 may include a plurality gaming machines installed in a casino, which in one embodiment are arranged in a bank, i.e., are arranged together, adjacently (not shown). It should be noted, however, that the system 2 may include any number of gaming machines that may be arranged in any manner, such as in a circle or along a curved arc, or positioned within separate areas of a casino floor, and/or separate gaming establishments such as different casinos. Furthermore, additional groups of gaming machines may be coupled to the network 14. In one embodiment, the system 2 may include a plurality of wagering gaming machines and a plurality of non-wagering gaming machines.

The player tracking system 10 tracks and stored transactions made on the gaming devices 12, which are related to a plurality of players or patrons. The player tracking system 10 compares the tracked transaction against a set of predetermined criteria for the purpose of generated or awarding an incentive award to one or more players. In general, one or more of the gaming devices may allow the player to play a game. The game utilizes one or more in-game machine assets. When a player tracking award is triggered for a player within the player tracking system 10, the player tracking system 10 may send a signal to the gaming device 12 which the player or patron is currently using to instruct the gaming device to award or demonstrate the awarding of the incentive award using at least one of the in-game assets stored on the gaming device.

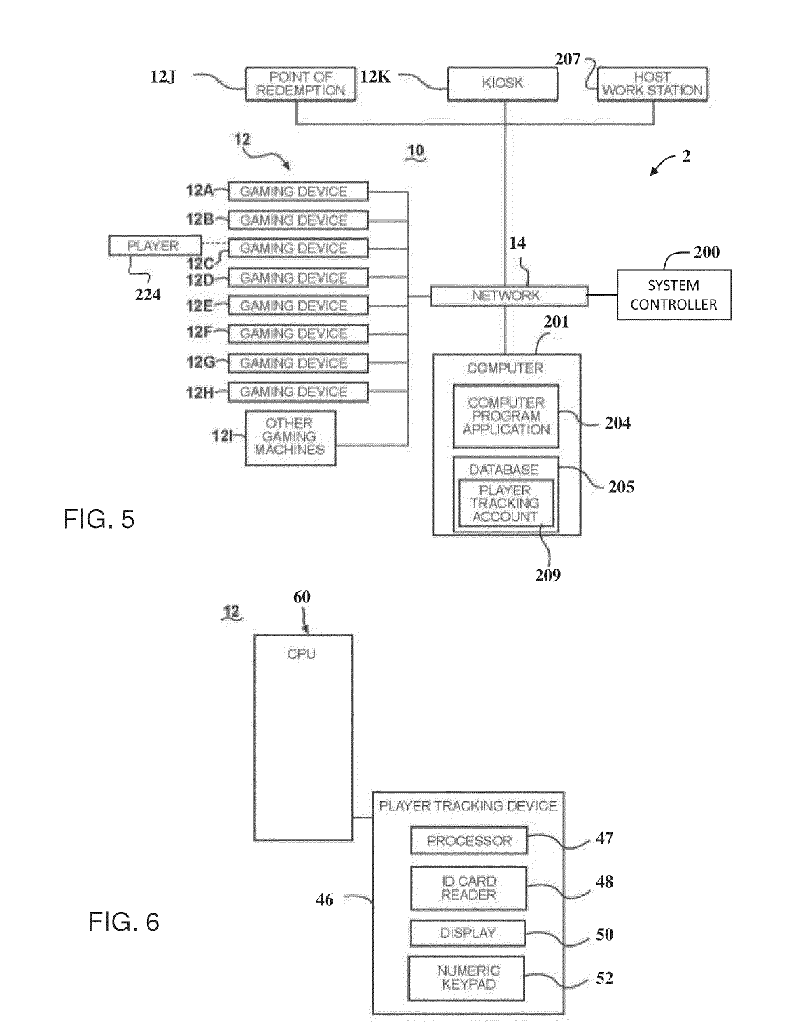

With particular reference to FIG. 5, in the illustrated embodiment the player tracking system 10 determines if a triggering event occurs based on the comparison between the predefined criteria within the player tracking system as related to the transactions within a player tracking accounts database 205. The player tracking accounts database 205 is populated through inputs from the gaming devices 12, and a player tracking (or host) workstation 207. The gaming devices 12 may include wagering gaming machines 12A . . . 12H and non-wagering gaming machines 12I, 12J. A non-wagering machine 12I, 12J can include any terminal or network device that allows for the generation of player metrics into the system, such as a redemption kiosk 12J or a point of sale kiosks 12K. The player tracking workstation 207 includes any type of device used by a system admin to modify the current metrics within the player tracking accounts database 205.

In one embodiment, the entertainment and monitoring system 2 may include additional functions such as, real-time multi-site, slot accounting, player tracking, cage credit and vault, sports book data collection, Point of Sale (POS) accounting, keno accounting, bingo accounting, and table game accounting, a wide area progressive jackpot, and electronic funds transfer (EFT). Additional details of exemplary entertainment and monitoring systems and/or player tracking systems, which may be used in the present invention, are disclosed in commonly owned, U.S. patent application Ser. No. 13/826,991, filed on Mar. 14, 2013, United States Patent Application Publication 2006/0058099A1, and United States Patent Application Publication 2003/0069071A1, all of which are hereby incorporated by reference.

As shown, the system 2 includes a plurality of gaming devices 12. Gaming devices 12 may include, but are not limited to gaming machines, electronic gaming machines (such as video slot, video poker machines, or video arcade games), electric gaming machines, virtual gaming machines, e.g., for online gaming, an interface to a table management system (not shown) for table games, or other suitable devices at which a patron or player 224 may interact or access a user or player account. It should be noted that the present invention is not limited to any number or type of gaming devices 12. In one embodiment, the gaming devices 12 may include gaming machines that are organized into banks (not shown), each bank containing a plurality of gaming machines 12. The gaming machine 12 and its operation will be discussed in further detail below.

The gaming devices 12 are connected via a network 14 to the player tracking system 10. The player tracking system 10 may include one or more player tracking servers 201. Each server 201 is generally located at one or more remote or central locations. The player tracking system 10 includes a computer program application 204 which maintains one or more player tracking accounts databases 205.

The computer program application 204 and player tracking accounts databases 205 may be used to record, track, and report accounting information regarding the gaming devices 12 and players of the gaming devices 12. Additionally, the computer program application 204 and player tracking accounts databases 205 may be used to maintain information related to player or player tracking accounts 209.

In general, the gaming devices 12 may be used by a user or player to access their player tracking account 209. For example, each of the wagering gaming machines 12 is playable by a player. The player may select one of the gaming machines 12 to play and insert a coin, credit, coupon, and/or player tracking card (not shown) into the chosen gaming machine 12. Generally, the gaming machines 12 have an associated number of credits or coins required in order to play. In the case of video slot or poker games, the game is played and an award in the form of credits may be awarded based on a pay table of the gaming machine 12.

The player may be identified by entry of a player tracking card into the player identification card reader and/or entry of a player identification number (PIN) on the numeric key pad.

### Gaming Machine

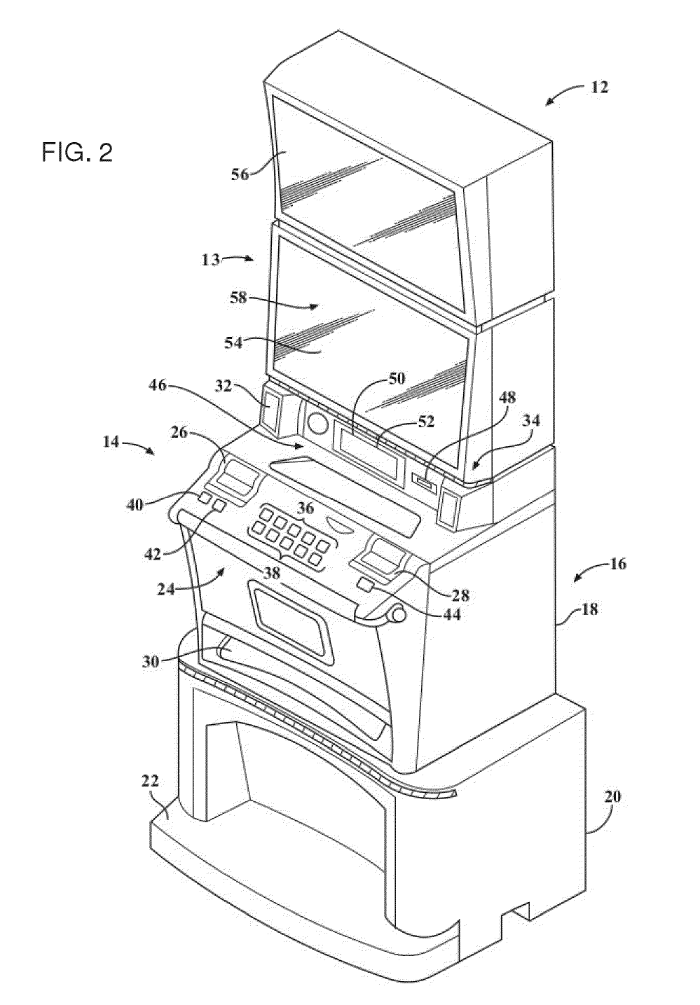

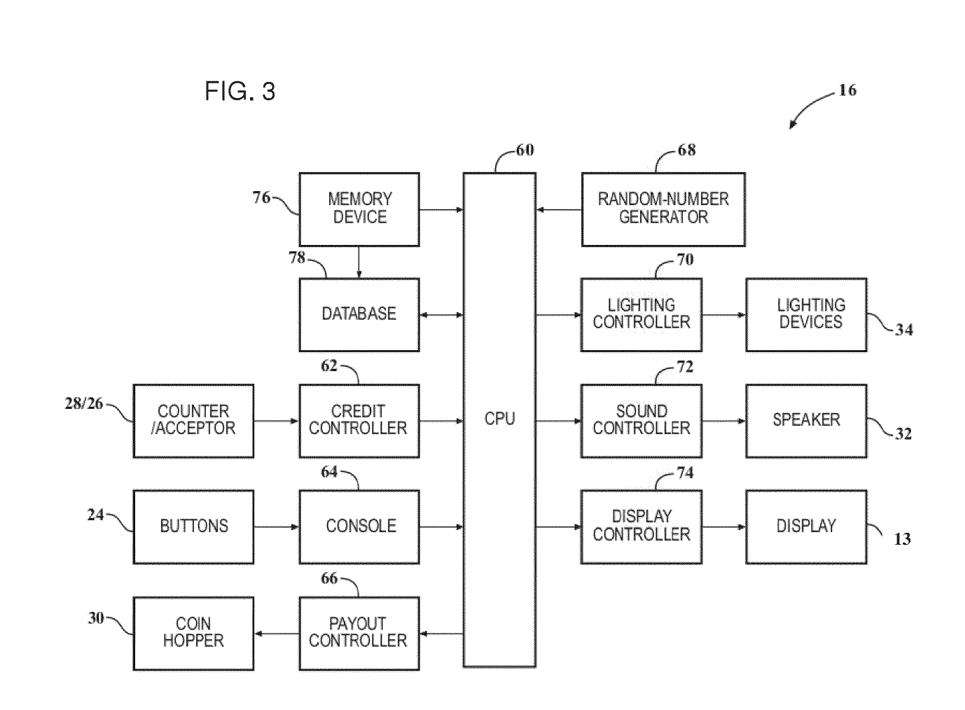

FIG. 2 is a perspective view of an exemplary gaming device 12 such as, for example a gaming machine. FIG. 3 is a schematic representation of a gaming controller 16 that may be used with the gaming device 12. A preferred embodiment of the gaming device 12 is a video gaming machine preferably installed in a casino. In the illustrated embodiment, the gaming machine 12 includes a display device 13 for displaying a plurality of games, a user input device 14 to enable a player to interface with the gaming machine 12, and the gaming controller 16 that is operatively coupled to the display device 13 and the user input device 14 to enable a player to play games displayed on the display device 13. The gaming machine 12 also includes a cabinet assembly 18 that is configured to support the display device 13, the user input device 14, and/or the gaming controller 16 from a gaming stand 20 and/or a supporting surface 22.

The display device 13 and the user input device 14 are coupled to the cabinet assembly 18 and are accessible by the player. In one embodiment, the gaming controller 16 is positioned within the cabinet assembly 18. Alternatively, the gaming controller 16 may be separated from the cabinet assembly 18, and connected to components of the gaming machine 12 through a network such as, for example, a local area network (LAN), a wide area network (WAN), dial-in-connections, cable modems, wireless modems, and/or special high-speed Integrated Services Digital Network (ISDN) lines.

In one embodiment, the user input device 14 includes a plurality of input buttons 24, a coin slot 26, and/or a bill acceptor 28. The coin slot 26 includes an opening that is configured to receive coins and/or tokens deposited by the player into the gaming machine 12. The gaming machine 12 converts a value of the coins and/or tokens to a corresponding amount of gaming credits that are used by the player to wager on games played on the gaming machine 12.

The bill acceptor 28 includes an input and output device that is configured to accept a bill, a ticket, and/or a cash card into the bill acceptor 28 to enable an amount of gaming credits associated with a monetary value of the bills, ticket, and/or cash card to be credited to the gaming machine 12. Moreover, the gaming machine 12 may also utilize a cashless wagering system (not shown), such as a ticket in ticket out (TITO) system (not shown). In one embodiment, the bill acceptor 28 also includes a printer (not shown) that is configured to dispense a printed voucher ticket that includes information indicative of an amount of credits and/or money paid out to the player by the gaming machine 12 during a gaming session. The voucher ticket may be used at other gaming machines, or redeemed for cash, and/or other items as part of a casino cashless system (not shown).

A coin tray 30 is coupled to the cabinet assembly 18 and is configured to receive a plurality of coins that are dispensed from the gaming machine 12. One or more speakers 32 are installed inside the cabinet assembly 18 to generate voice announcements and/or sound effects associated with game play. The gaming machine 12 also includes one or more lighting devices 34 that are configured to blink and/or change brightness and color in specific patterns to produce lighting effects to enhance a visual gaming experience for the player.

In one embodiment, the input buttons 24 include a plurality of BET switches 36 for inputting a wager on a game, a plurality of selection switches 38 for selecting a betting line and/or card, a MAXBET switch 40 for inputting a maximum wager, a PAYOUT switch 42 for ending a gaming session and dispensing accumulated gaming credits to the player, and a start switch, i.e., a SPIN/DEAL button 44 to initiate an output of a game.

In the illustrated embodiment, the BET switches 36 include five switches from 1BET to 5BET to enable a player to wager between a minimum bet up to 5× minimum bet. Each selection switch 38 corresponds to a betting line such as, for example, a payline and/or symbol for a reel game, one or more cards for a card game, and/or a symbol for a roulette game, to enable a player to associate a wager with one or more betting lines. The MAXBET switch 40 enables a player to input the maximum bet that a player can spend against one time of a game. The PAYOUT switch 42 enables a player to receive the amount of money and/or credits awarded to the player during a gaming session, which has been credited onto the gaming machine 12.

The gaming machine 12 may also include a player tracking device 46 that is coupled to the gaming controller 16 for identifying the player and/or a player tracking account 209 that is associated with the player 224. The player tracking account 209 may include, but is not limited to, gaming credits available to the player for use in playing the gaming machine 12. The player tracking device 46 is configured to communicate player account information between a player tracking server 201 and the gaming machine 12. For example, the player tracking device 46 may be used to track bonus points and/or credits awarded to the player during a gaming session and/or track bonus and/or credits downloaded to the gaming machine 12 from the player tracking system.

The player tracking device 46 is coupled to the gaming cabinet assembly 18 and includes a player identification card reader 48, a data display 50, and a keypad 52. The player identification card reader 48 is configured to accept a player tracking card (not shown) inserted by the player, and read information contained on the player tracking card to identify the player account information. The player identification card reader 48 may include, but is not limited to, a barcode reader, a magnetic card reader, and/or a radio frequency identification (RFID) card reader. The keypad 52 is configured to accept a user selection input such as, for example, a unique player personal identification number (PIN) to facilitate enabling the gaming machine 12 to identify the player, and access player account information associated with the identified player to be displayed on the data display 50. In one embodiment, the data display 50 includes a touchscreen panel that includes the keypad 52. Alternatively, the data display 50 and the keypad 52 may be included in the display device 13.

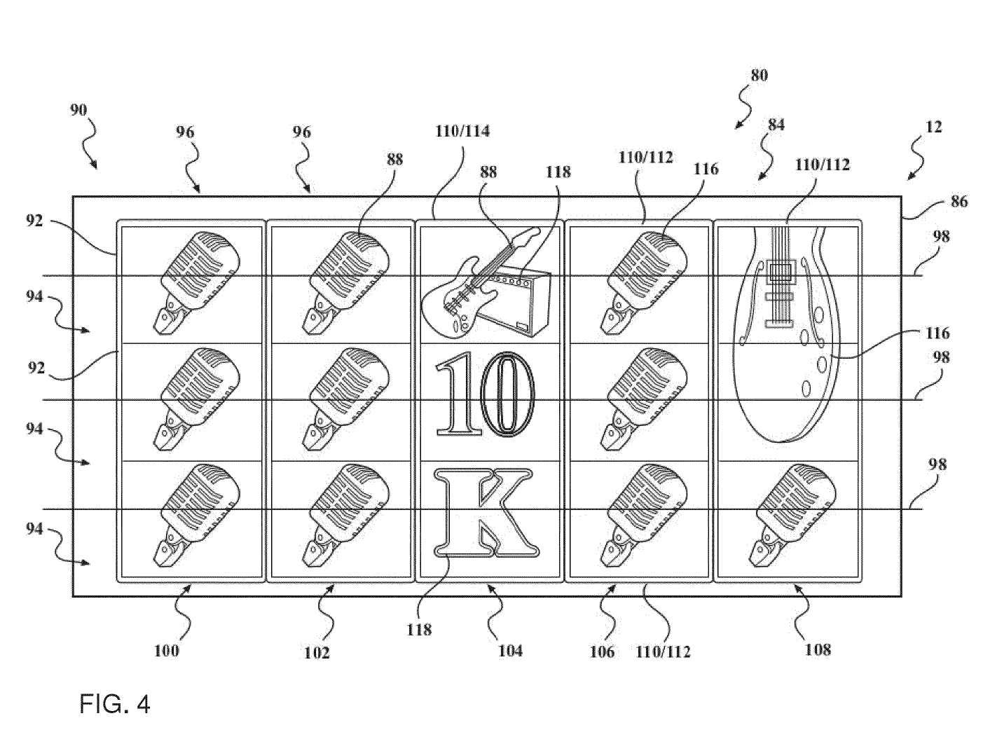

In one embodiment, the display device 13 includes a first display 54 and a second display 56. The first display 54 is configured to display a game screen 58 (shown in FIG. 4) including indicia and/or symbols for use in a game, e.g., cards used by a card game, roulette wheel and symbols used in a roulette game, and reels used in a reel game. The game screen 58 may include any type of game including, but not limited to, a video slot game, a keno game, a blackjack game, a video poker game, or any type of game which allows a player to make a wager, play a game, and potentially provide the player an award based on an outcome of the game and a paytable. The second display 56 is configured to display game play instructions for performing the game including, but not limited to, playing instructions, paytables, paylines, betting lines and/or any other information to enable the gaming machine 12 to function as described herein. Moreover, each display 54 and 56 may be configured to display at least a portion of the game screen 58 and/or game play instructions. In one embodiment, the first and second displays 54 and 56 each include a flat panel display, such as a cathode ray tube display (CRT), a liquid crystal display (LCD), a light-emitting diode display (LED), a plasma display, and/or any suitable visual output device capable of displaying graphical data and/or text to a user. Alternatively, a single component, such as a touch screen, may function as both the display device 13 and as the user input device 14. In an alternative embodiment, the first display 54 and/or the second display 56 includes a plurality of mechanical reels displaying a plurality of game symbols.

Referring to FIG. 3, in one embodiment, the gaming controller 16 includes a processor, i.e., a central processing unit (CPU) 60, a credit controller 62, a console unit 64, a payout controller 66, a random-number generator (RNG) 68, a lighting controller 70, a sound controller 72, a display controller 74, a memory device 76, and a database 78. Memory device 76 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the CPU 60 to store, retrieve, and/or execute instructions and/or data.

The CPU 60 executes various programs, and thereby controls other components of the gaming controller 16 according to player instructions and data accepted by the user input device 14. The CPU 60 in particular executes a game program, and thereby conducts a game in accordance with the embodiments described herein. The memory device 76 stores programs and databases used by the CPU 60. Moreover, the memory device 76 stores and retrieves information in the database 78 including, but not limited to, a game type, a number of reels associated with a game, a number of reel strips associated with each reel, a number of symbol positions being displayed on each reel strip, a type of symbols being displayed on each symbol position, a predefined set of normal symbols, a predefined set of special symbols, image data for producing game images and/or screens on the display device 13, and temporarily stores variables, parameters, and the like that are used by the CPU 60. In addition, the memory device 76 stores indicia, symbol weights, pay tables, and/or winning combination tables which represent relationships between combinations of random numbers and types of awards. In one embodiment, the memory device 76 utilizes RAM to temporarily store programs and data necessary for the progress of the game, and EPROM to store, in advance, programs and data for controlling basic operation of the gaming machine 12, such as the booting operation thereof.

The credit controller 62 manages the amount of player's credits, which is equivalent to the amount of coins and bills counted and validated by the bill acceptor 28. The console unit 64 is coupled to the user input device 14 to monitor player selections received through the input buttons 24, and accept various instructions and data that a player enters through the input buttons 24. The payout controller 66 converts a player's credits to coins, bills, or other monetary data by using the coin tray 30 and/or for use in dispensing a credit voucher via the bill acceptor 28.

The lighting controller 70 controls one or more lighting devices 34 to blink and/or change brightness and color in specific patterns in order to produces lighting effects associated with game play. The sound controller 72 controls the speakers 32 to output voice announcements and sound effects during game play. The display controller 74 controls the display device 13 to display various images on screens preferably by using computer graphics and image data stored in the memory device 76. More specifically, the display controller 74 controls video reels in a game screen displayed on the first display 54 and/or the second display 56 by using computer graphics and the image data.

The RNG 68 generates and outputs random numbers to the CPU 60 preferably at the start of each round of game. The CPU 60 uses the random numbers to determine an outcome of a game. For example, if the game is a video slot game, the CPU 60 uses the RNG 68 to randomly select an arrangement of symbols to be displayed on video reels. Moreover, the CPU 60 generally uses random numbers generated by the RNG 68 to play the games, and to determine whether or not to provide an award to a player. In addition, the CPU 60 generates game outcomes including combinations of random numbers, and compares the generated combinations with winning combinations stored in the winning combination table to determine if the generated outcome is a winning outcome that is associated with a type of award.

FIG. 4 is an exemplary graphical display of a game that is displayed by the gaming device 12 shown in FIG. 2. In the illustrated embodiment, the gaming controller 16 is configured to display the game on the display device 13. In one embodiment, the game includes a main game 80, such as a video slot game. However, it should be noted that the main game 80 may be any type of game upon which a player could make a wager including, but not limited to a keno game, a blackjack game, a video poker game, or any type of game that enables the gaming machine 12 to function as described herein. In the illustrated embodiment, the main game 80 is displayed on the first display 54. Alternatively, the main game 80 may be displayed on the first display 54 and/or the second display 56.

In general, during play of the main game 80, the gaming controller 16 randomly generates an outcome 84 of the main game 80 and displays the generated game outcome 84 in a display area 86. The gaming controller 16 randomly selects a plurality of game symbols 88 from a predefined set of possible game symbols and displays the selected game symbols 88 associated with the generated game outcome 84 in the game display area 86.

In the illustrated embodiment, the plurality of game symbols 88 are displayed in a grid 90 having a plurality of cells 92 arranged along a plurality of rows 94 and a plurality of columns 96. Each cell 92 displays one or more game symbols 88 associated with the game outcome 84. In the illustrated embodiment, the gaming controller 16 displays the game symbols 88 within a plurality of reels 100, 102, 104, 106, 108. Each reel 100, 102, 104, 106, 108 is associated with a corresponding column 96. The main game 80, in one embodiment, includes 5 reels with 3 cells 92 displayed in the display area 86 per reel (a “3×5” arrangement). Alternatively, other reel arrangements may be used such as, for example, 4, 5, 5, 5, and 4 cells per reel, respectively (a “4-5-5-5-4” arrangement), 3-4-3-4-3, or 4-5-4-5-4 arrangements or arrangements with the same number of cells per column, such as 3×3, 3×4, 4×5, or 5×5 configurations. The main game 80 also includes a plurality of paylines 98 that extend across one or more cells 92 to indicate, to the player, a combination of game symbols 88. In one embodiment, the gaming machine 12 displays the main game 80 via a plurality of mechanical reels (not shown) that include a plurality of symbols displayed on a circumferential surface of each reel.

Each slot game is generally played in a conventional manner. The player makes a wager, which may be based on a predetermined denomination and a selected number of paylines, the gaming controller 16 randomly generates an outcome for the game, spins the reels, and selectively stops the reels to display a game symbol 88 in each of the display cells 92. If a predetermined pattern of symbols 88 is randomly chosen for each cell 92 associated with a played payline 98, the player may be awarded a payout based on the payline, the wager, and a predetermined paytable. Moreover, the player may be awarded a payout if the combination of symbols associated with a selected payline is a winning combination. In addition, a player may receive a bonus feature and/or a bonus game based on the combination of symbols associated with the selected payline and/or the appearance of one or more predefined symbols in the game outcome 84. Many variations to the above described general play of a slot game fall within the scope of the present invention. Such slot games are well-known in the art, and are therefore not further discussed.

In the illustrated embodiment, the gaming machine 12 receives a signal, from the user input device 14, that is indicative of a player's selection to initiate a gaming session including a wager amount, and a selection of one or more paylines 98 associated with a predefined set of cells 92 within the displayed grid 90. In the illustrated embodiment, the gaming machine 12 is a multi-line game, i.e., the paylines include horizontal paylines and/or diagonal pay-lines, and/or zig-zag paylines. Moreover, the user input device 14 may allow the player to toggle to increase the bet per payline a credit at a time (up to the maximum bet). The gaming controller 16 randomly generates an outcome of the main game 80, and displays the generated outcome on the display device 13. In one embodiment, the gaming controller 16 is configured to rotate, and/or spin each reel 100, 102, 104, 106, 108 to initiate a game play, and stop each reel 100, 102, 104, 106, 108 to display a plurality of symbols 88 associated with the randomly generated outcome. In addition, the gaming controller 16 is adapted to determine if the generated outcome is a winning outcome based on the displayed game symbols 88, a pay-table, a wager, and one or more selected paylines 98. More specifically, the gaming device 12 determines if a combination of symbols 88 arranged along the selected payline 98 is a winning combination. The gaming controller 16 may provide an award in response to the outcome of the main game 80. In general, the term “award” may be a payout, in terms of credits or money. Thus, gaming controller 16 may award a regular payout in response to the outcome of the main game 80. However, it should be noted that the term award may also refer to other types of awards, including, prizes, e.g., meals, show tickets, etc. . . . , as well as in-game awards, such as free games or awarding the player one or more wild symbols or stacked wild symbols in each of the games.

The illustrated embodiment can also include a bonus feature or secondary game in addition to the main game on the gaming machine. The bonus feature or secondary game is an add-on to the main game utilizing any in-game machine asset (discussed in more detail below). A bonus feature or secondary game is considered an add-on to the main game that occurs during game play. The bonus feature or secondary game can used any in-game machine asset that is used to display an award related to the main game. Such awards include free spins, credits, a credit multiplier, or additional pseudo game-play unrelated to the main game. The bonus feature or secondary game can be in any of the wagering or non-wagering formats as described above (slots, video poker, etc.). A bonus feature or secondary game may also be similar to the main game through the use of additional random numbers in order to continue randomized, wager-based game play. A bonus feature or secondary game may include any additional game play and grant awards based on any particularized triggers built into the main game of the game machine. It should be noted that the game may only include the main game 80. Alternatively, the game may include the main game 80 and one or more bonus features and/or one or more secondary games. It should be noted that the present invention is not limited to any specific bonus feature or secondary game (or type thereof). Exemplary bonus features or secondary games are disclosed in U.S. Pat. No. 7,824,260, U.S. Pat. No. 8,052,515, U.S. Pat. No. 8,096,869, U.S. Pat. No. 8,303,397, and United States Patent Application Publication 2011/0223985, all of which are hereby incorporated by reference.

In-game machine assets are defined as any pre-coded or generated gaming elements used by the gaming machine in order to implement the main game or any of the bonus features during game play. Such assets include text, graphics, animations, audio-video elements, game-play mechanics (i.e., game rules or constructs for wagering or non-wagering games). The assets may be pre-coded into the gaming machine 12 or generated by the machine during game play. Such assets may can also be used by the gaming machine 12 during the main game or reserved exclusively by the machine for the representation of a bonus feature only.

### Player Tracking System and Method

In one embodiment, the player tracking system 10 and method may be embodied or implemented via an entertaining and monitoring system which is shown in block diagram form in FIG. 1. The player tracking system may include additional functions such as, real-time multi-site, slot accounting, player tracking, cage credit and vault, sports book data collection, Point of Sale (POS) accounting, keno accounting, bingo accounting, and table game accounting, a wide area progressive jackpot, and electronic funds transfer (EFT).

As shown, the system 10 may be associated with and/or include a plurality of gaming devices 12. Gaming devices 12 may include, but are not limited to gaming machines, electronic gaming machines (such as video slot, video poker machines, or video arcade games), electric gaming machines, virtual gaming machines, e.g., for online gaming, an interface to a table management system (not shown) for table games, kiosks 12K, point of sale or redemption terminals 12J, or other suitable devices at which a patron may interact or access a user or player account. However, it should be noted that the present invention is not limited to any number or type of gaming devices 12. In one embodiment, the gaming devices 12 are organized into banks (not shown), each bank containing a plurality of gaming devices 12.

Other types of gaming machines which may be included (see above) are indicated with reference number 12I.

The gaming devices 12 are connected via a network 14 to one or more host computers or servers 201, which are generally located at a remote or central location. The computer 201 includes a computer program application 204 which maintains one or more player tracking accounts databases 209.

The computer program application 201 and databases 205 may be used to record, track, and report accounting information regarding the gaming devices 12 and players 224 of the gaming devices 12. Additionally, the computer program application 204 and database(s) 205 may be used to maintain information related to player or player tracking accounts (see below).

In general, the machines 12 may be used by a user or player, i.e., to access their player account. For example, a gaming device 12 is playable by a player 224. The player 224 may select one of the gaming devices 12 to play and insert a coin, credit, coupon, and/or player tracking card (not shown) into the chosen gaming device 12. Generally, the gaming devices 12 have an associated number of credits or coins required in order to play. In the case of video slot or poker games, the game is played and an award in the form of credits may be awarded based on a pay table of the gaming device 12.

Input to the gaming device 12 may be accomplished via mechanical switches or buttons or via a touchscreen interface (discussed above).

The player 224 is identified via the player tracking card and/or a player identification number entered into player tracking device 46 at each gaming device 12 (see above). Player tracking accounts may be used, generally, to provide bonuses or player tracking awards, to a player, in addition to the award designated by, in the case of a video slot or poker machine, the gaming device 12 paytable. These bonuses may be awarded to the player 224 based a set of criteria, including, but not limited to, a) the player's play on the gaming device 12, b) the player's overall play, c) play during a predetermined period of time, and d) the player's birthday or anniversary, or e) any other definable criteria. Additionally, bonuses may be awarded on a random basis, i.e., to a randomly chosen player or randomly chosen main game 80. Bonuses may also be awarded in a discretionary manner or based on other criteria, such as, purchases made at a gift shop or other affiliated location.

In one embodiment, the player tracking device 46 includes a processor 47, a player identification card reader 48 and/or a numeric keypad 52, and a display 50. In one embodiment, the display 50 is a touchscreen panel and the numeric keypad 52 is implemented thereon.

The player 224 may be identified by entry of a player tracking card into the player identification card reader 48 and/or entry of a player identification number (PIN) on the numeric key pad 52. The play tracking device 46 may also be used to communicate information between the computer 201 and the corresponding gaming device 12. The player tracking device 46 may also be used to track bonus points, i.e., incentive points or credits, downloaded from the computer 201.

In one aspect of the present invention, each player tracking device 46 is associated with one of the electronic gaming devices 12. The player tracking devices 46 identify patrons interacting with the system 2, for tracking wagers made by the players on the electronic gaming devices 12 and record wager data associated with each wager made by the player and a respective electronic gaming device 12. In one embodiment, the wager data includes a device type associated with respective gaming machine, an electronic gaming machine identifier, the theoretical hold percentage associated with the respective gaming machine, and an amount of the respective wager. The wager data may also include a player ID and a date/time stamp.

The computer or server 201 is in communication with the player tracking devices 46 and the non-gaming terminals 12I, 12J, 12K for receiving the wager data associated with the patrons and the respective gaming device 12 from the player tracking device 46 and storing the wager data in the database 205 and, for receiving transaction data associated with a transaction associated with the patrons' use of the non-gaming terminals 106 and storing the transaction data in the database. The computer 201 may also establishes a player rating associated with each player as a function of the wager data and the transaction data.

In one aspect of the present invention, the bonuses are awarded as bonus points. In one embodiment, the bonus points are incentive points. In another embodiment, the bonus points are credits.

The incentive points may be converted to credits using a predetermined ratio. The predetermined ratio may be 1 or any other desired ratio. The predetermined ratio may also be varied based on determined criteria, e.g., the gaming device 12 being played, the player, or the time of day. Incentive points may be designated as cashable or non-cashable. As described below, the incentive points in a player account may be downloaded to one of the gaming devices 12 for play.

Incentive points stored in the player account may be designated as cashable or non-cashable. In one embodiment, the player account may include only cashable incentive points. In another embodiment, the player account may include only non-cashable incentive points. In a third embodiment, the player account may include both cashable and non-cashable incentive points. In still another embodiment, the player account may include incentive points, cashable and/or non-cashable, and credits, cashable and/or non-cashable. Cashable credits, or incentive points converted into credits, may be downloaded to a gaming device 12. When the player has finished playing the gaming device 12, any remaining credits may be cashed out, i.e., retrieved as coins or placed on a printed ticket or player tracking card for redemption or play on another gaming device 12.

Non-cashable credits must be played. When the player stops playing gaming machine 12C, any remaining non-cashable credits which were downloaded to the gaming machine 12C are either lost or uploaded back to the player account (see below).

The database 205 tracks the player account for each player in the player tracking system. In the illustrated example, the following is tracked for each player: account number, incentive points, name, cashable credits and non-cashable credits. Thus in this example, bonus points in the form of incentive points, cashable credits and non-cashable credits may be awarded.

In one aspect of the present invention, bonus points are awarded via electronic vouchers, i.e., records in the database 205. A voucher is created each time bonus points are awarded. Each voucher has a voucher number and an amount (in the case a dollar or credit amount). Each voucher is assigned to a player account and includes the player account number to which it is assigned. Each voucher may include additional parameters or fields based on the needs of the system 2. For example, an expiration date could be included which gives a date at which the respective voucher expires. The voucher may also designate the bonus points as cashable or non-cashable.

In one aspect of the present invention the computer 201 may create a first voucher and assign a first number of bonus points to the first voucher. The computer 201 may also create a second voucher and assign a second number of bonus points to the second voucher. The first and second vouchers may be assigned to a player account. Each voucher has a parameter. The parameter of the first voucher has a first value and the parameter of the second voucher has a second value.

In one embodiment, the bonus points are incentive points which may be converted to credits and downloaded to the gaming device 12. In another embodiment, the bonus points are credits which may be downloaded to the gaming device 12.

In one embodiment, the gaming device 12 may display to the player 224 a list of the vouchers which have been assigned to their player account. The player 224 may then indicate at least one voucher to download. The list may displayed whenever appropriate, for example, when the player 224 is identified to the system 2, when the player requests the list (through a menu system), when a new voucher has been created, or any other suitable time. In one embodiment, the list may be displayed on the display 13. In another embodiment, the list may be displayed on the player tracking device display 50.

The first and second values of the parameters of the first and second vouchers may be equal or different. For example, in one embodiment the parameter relates to an expiration date of the respective voucher. The expiration date may be a function of the date of the voucher was created. Thus, the expiration dates of the first and second vouchers may be different if the vouchers were created on different days or may be the same if created on the same day.

In another embodiment, the parameter is one of cashable and non-cashable. The computer 201 may designate a voucher as cashable or non-cashable. Typically, this is defined by predefined criteria based on how the voucher was created. If the bonus points for a specific voucher are incentive points, the incentive points may be converted to credits prior to downloading to the gamine machine 12. As described above, this is done using a predetermined ration which may be 1 or some other ratio.

In one embodiment, the gaming device 12 may provide an indication to the player 24 when the first voucher or second voucher has been assigned to the player account. For example, the indication may be an audio signal and/or a visual signal.

In one embodiment, the parameter may be an expiration date of the respective voucher. Each voucher may also include a second parameter designating the respective bonus points as being cashable or non-cashable.

In one embodiment, the computer 201 may convert the first number of bonus points to a first number of credits and download the first number of credits to the player tracking device 38.

In another embodiment, the gaming device 12 has a credit meter for tracking available credits for play of the gaming device by the player 224. The computer 201 may convert the first number of bonus points to a first number of credits and download the first number of credits to the credit meter.

In one embodiment, the parameter may be one lump-sum and pay for play. The computer 201 may convert the first number of bonus points to credits and download the credits to the credit meter if the first voucher is designated as lump-sum.

In one embodiment of the present invention, the gaming device 12 is capable of accepting a variable wager. The variable wager has a maximum wager value or MAX BET. In one embodiment, the maximum wager value is equal to the lesser of a value defined by the configuration of the gaming device 12, a value defined by the incentive setup, or the remaining balance of bonus points. The computer 201 converts the first number of bonus points associated with the first voucher to a first number of credits and downloads the first number of bonus points to the player tracking device 46 as credits. The gaming device 12 allows the player 224 to place a wager and play the gaming device 12. The gaming device 12 decrements the wager from the credit meter, decrements the maximum wager from the player tracking device 46, and credits the maximum wager to the credit meter in response to the player 224 playing the gaming device 12.

In another embodiment of the present invention, the player account is credited with a first number of bonus points. The bonus points are downloaded to the player tracking device 38 as credits. The player 224 places a wager and the gaming device 12 is played. If the total of the player's wagers (over one or more games) is greater or equal to a predetermined value, i.e., a predetermined match play amount, then the match play amount is decremented from the player tracking device 46 and the match play amount is credited to the credit meter. Otherwise, the player 224 may place another wager.

In one aspect of the present invention, the player tracking device 46 provides an interface for interaction between the player 224 or other user (not shown), such as a slot employee or slot technician, and the host computer 201, i.e., player tracking system. As discussed above in one embodiment, the display 50 is a touchscreen display which allows information to be displayed to the player 224 or user, as well as provide interactive buttons or menus for receiving input. Furthermore, the keypad 52 may be implemented on the display 50 and displayed on the display 50 as appropriate or required.

Furthermore, as discussed above, the player tracking device 38 may display a list of vouchers assigned to the player 24. The player 24 may be allowed to select a voucher, or a number of available bonus points or credits, to download. Once the player selects a voucher or a number of credits or points to download, the credits may be downloaded to the credit meter on the gaming device 12 and are then available for use.

### Incentive Award System and Method

In one aspect of the present invention, certain player tracking awards may be awarded directly by one of the gaming devices 12 instead of requiring the player 224 to download the credits using the player tracking device 46. This may occur automatically, without the player actively requesting that an award be applied to the credit meter. In one aspect, the player tracking award may be awarded in manner which is seamless or nearly seamless to the player. For example, advanced incentive award may be awarded through a feature or secondary game. The bonus feature or secondary game may be (1) one of the feature or secondary games associated with the main game, (2) a modified bonus feature or secondary game, and (3) a bonus feature or secondary game which is dedicated to awarding the player tracking award. In general, the bonus feature or secondary game used to award the incentive award will be related to the theme of the main game and utilize at least one in-game machine asset.

Generally speaking, the theme of the main game relates to the characters, motifs, or branding within the game. These themes are conveyed through any number of in-game machine assets. In-game machine assets can include graphics, audio/video, or in-game mechanics that are pre-coded or generated by the gaming device in order to represent the game themes.

In aspect of the present invention, the player tracking system 10 identifies that a specific player 224 is eligible for a player tracking bonus or incentive award. In one embodiment, the specific award or bonus is designated as a bonus or award which may be awarded via a gaming device 12. In general, only specific gaming machine which have been designed to work with the system 2 may be used to award the bonus or incentive award. Once the player tracking system 10 has identified that the player 224 is eligible for the bonus or incentive award, the gaming machine 12 at which the player is playing must be identified. In one embodiment, the player tracking system 10 waits for the player to logon into a gaming machine 12 via the player tracking module 46. If the gaming machine 12 the player logs into is gaming machine 12 which may award the player tracking incentive or bonus award directly, the player tracking system 10 sends the gaming machine 12 an incentive award signal. The gaming machine 12, in response to receiving the incentive award signal awards the player the incentive award using one of the game assets stored on the gaming machine 12. In this manner, the player 224 does not need invoke, or interact with, the player tracking system 10 in order to be awarded or utilize the bonus award. By using one or more game assets stored on the gaming machine 12, the awarding of the bonus award may be seamless to the player.

The gaming machine 12 can generate an incentive feature in any of ways mentioned at the beginning of this section. First, a bonus feature or secondary game may be associated with the main game, but utilized by the system 2 in order to grant an incentive award generated by the system. This embodiment is present in gaming machines that are pre-coded to contain both a main game and a bonus feature or secondary game separate from the incentive award system and can utilize the bonus feature or secondary game in order to grant an additional incentive awards received by the gaming machine. Such gaming machines would seamlessly integrated into the incentive award system and grant additional awards without generating a different gaming experience for the player.

Second, the bonus feature or secondary game may be modified in order to grant the incentive award during game play. In this embodiment, a gaming machine 12 may grant limited access to the in-game machine assets (discussed above) in order to generate a particular bonus feature or secondary game for a player during game play. Such limitation would generate a particular bonus feature based on the incentive award and any additional instructions conveyed by the system.

Third, the bonus feature or secondary game may be based on dedicated in-game machine assets that are only meant for the incentive award. In this embodiment, the gaming machine is programmed to retain all in-game machine assets associated with the main game exclusively for use with the main game. Additional in-game machine assets would be present within the gaming machine 12 or sent to the gaming machine along with the incentive award in order to present the incentive award to the player.

In the illustrated embodiment, the gaming controller 16 is configured to display the bonus feature on the display 13. In one embodiment, the bonus feature is a simulated video slot game that granted the incentive award regardless of the outcome of the game. However, it should be noted that the bonus feature may be any type of bonus feature utilizing the game assets stored or generated within the game machine 12 including, but not limited to a simulated wager game, a skills-based game, an audio/video representation indicative of the incentive award, or any type of game that enables the gaming machine 12 to function as described herein. In the illustrated embodiment, the bonus feature is displayed on the first display. Alternatively, the bonus feature may be displayed on the first display and/or the second display.

Through this method, the system can present the incentive award with the use of in-game machine assets and create a seamless user experience for the player.

### Floor-Wide System for Delivering Bonus Game

In another aspect of the present invention, player tracking awards, incentive awards and the like may be awarded through a floor-wide system for delivering bonus game or incentive bonus game.

In the illustrated embodiment, the system controller 200 is configured to generate a bonus feature game 250 for use in providing player tracking awards and/or incentive awards and the like to a plurality of players. In one embodiment, the incentive award may be a two part award. The initial part may be entry of into the incentive bonus feature game 250. The second part of the incentive award may be an award based on the outcome of the incentive bonus feature game 250.

With respect to qualification to enter the incentive bonus game, using the system 2, the casino operator may establish a set of predefined criteria to qualify for the event. Criteria may include, but are not limited to a) the player's play on the gaming device 12, b) the player's overall play, c) play during a predetermined period of time, and d) the player's birthday or anniversary, or e) any other definable criteria.

In one embodiment, once a player has qualified for the incentive bonus game, a message will appear informing the player that they have qualified for the event.

In one embodiment, the incentive bonus game (and any associated messaging) is displayed on the display 50 of the player tracking device 46 associated with the gaming device 12 the player is using. In another embodiment of the present invention, the incentive bonus game (and any associated message) is displayed on one of the displays 13, 54, 56 of the gaming device 12. The incentive bonus game may be provided thematically using a theme associated with the incentive bonus game or may be provided using game assets associated with the gaming device 12, as detailed above.

In one embodiment, the advanced bonus game is based on a multiple round elimination format. In one exemplary embodiment, after the advanced bonus game is initiated, qualified players are instructed to pick a character or an object from a presented choice of characters or objects. The goal of the advanced bonus game is to being the sole survivor.

Qualified players are prompted to make a selection of a character or an object and the FBG will play through a series of elimination rounds that employ movies showing the actual elimination event. As the game progresses through the various rounds, certain players will be eliminated and other players will progress through to the next round.

Operators can select the number of elimination rounds, e.g., between 2-4 elimination rounds with the resulting outcome of the game being a single survivor.

In one embodiment, multiple players may select the same character or object. Thus, if the character or object selected by multiple player is the sole survivor, then all players who selected that character will be awarded an award, which may be a share of a total award. Alternatively, each winning player may win a predetermined award, independent of the number of winners.

In general, in one aspect of the present invention, the prize money will be distributed to the players as non-cashable bonus play cash.

The incentive bonus game may be displayed on one or more of the displays of the gaming device 12, the display associated with the player tracking device 46, digital signage within the casino which may be seen by others, and/or any other display.

Qualified players will be required to insert their player's card into any machine prior to the event time. Once the system identifies the player as being qualified for the event, players will be presented with a choice of 8 selections (objects or characters), when the player makes their selection, they will be placed into a holding status until all players have joined and made their selections. At the defined time, the FBG will start and display the first series of elimination movies where some players will be eliminated. All players that survive the first round of eliminations will progress to round 2 where more players will be eliminated. This process will repeat itself until the final round where a single winner will be revealed.

In one aspect of the present invention, the outcome of each round of the incentive bonus game or the outcome of the incentive bonus game may be predetermined by player characteristics, e.g., the player's ranking relative to the other qualifying players.

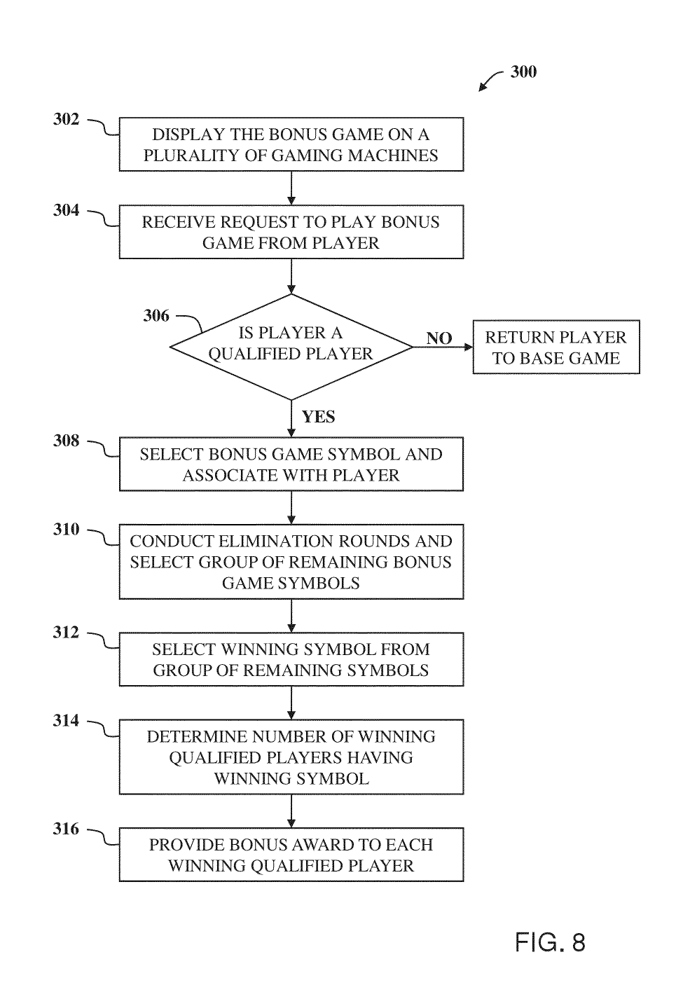

Referring to FIG. 7, in one embodiment, the system controller 200 may include a processor 252, a random-number generator (RNG) 254, a display module 256, a bonus feature module 258, a memory device 260, and a database 262. The memory device 260 includes a computer readable medium that enables the processor 252 to store, retrieve, and/or execute instructions and/or data. The processor 252 executes various programs, and thereby controls other components of the system controller 200 according to player instructions and data accepted by the player tracking system 10 and/or the gaming devices 12. The memory device 260 stores and retrieves information in the database 262 including, but not limited to, bonus game qualification criteria, bonus game triggering conditions, bonus game types, bonus awards, type of awards, bonus game symbols, and/or image data for producing game images and/or game screens, and temporarily stores variables, parameters, and the like in the database 262 for use by the processor 252.

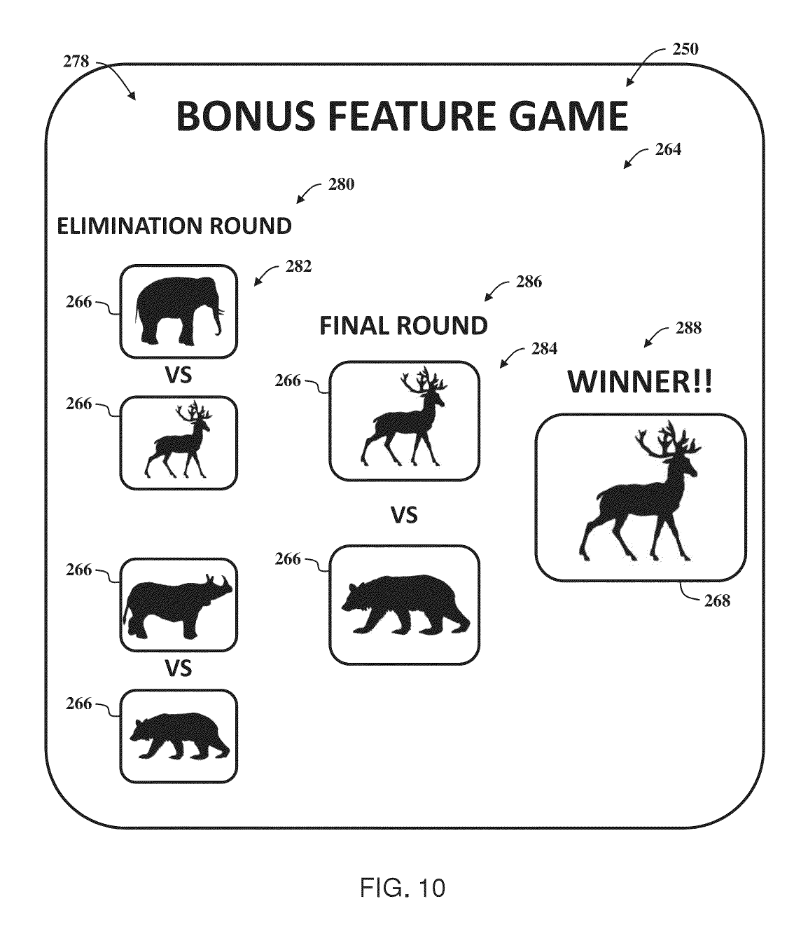

The display module 256 is connected each of the player tracking devices 46 and gaming devices 12 to display various images on each of the corresponding display devices 50 and 13. In the illustrated embodiment, the display module 256 is configured to display the bonus feature game 250 on one or more of the display devices 13 and 50 to enable a corresponding player to play and/or participate in the bonus feature game 250. In one embodiment, the display module 256 may display the bonus feature game 250 on a bonus game screen 264 (shown in FIGS. 9 and 10). In addition, the display module 256 may be configured to display the bonus feature game 250 simultaneously with a main game 80 being displayed on a corresponding gaming device 12. For example, in one embodiment, the display module 256 may display the bonus feature game 250 on the second display 56 as the display controller 74 is displaying the main game 80 on the first display 54 (shown in FIG. 2). In addition, the display module 256 may display the bonus feature game 250 on the gaming machine display device 13 and/or the player tracking display device 50.

The RNG 254 generates and outputs random numbers to the processor 252 for use with the bonus feature game 250. For example, in one embodiment, the processor 252 may receive random numbers from the RNG 254 at the start of each elimination round for use in determining the game symbols that are selected for subsequent rounds. Moreover, the processor 252 may use random numbers received from the RNG 254 to select bonus game symbols being associated with each participating player at the start of the bonus feature game 250.

The bonus feature module 258 includes a game program for use in executing the bonus feature game 250. In the illustrated embodiment, the bonus feature module 258 is configured to display the bonus feature game 250 including a plurality of bonus game symbols 266 that compete in a series of elimination rounds until one of the character symbols is determined to be a winning bonus game symbol 268. The bonus feature module 258 includes a player qualification unit 270 and a symbol selection unit 272.

In the illustrated embodiment, the player qualification unit 270 determines a set of qualification criteria that is associated with the bonus feature game 250. The set of qualification criteria include criteria that is indicative of qualified player that is eligible to participate in the bonus feature game 250. In addition, the player qualification unit 270 is configured to retrieve player criteria associated with a player requesting to participate in the bonus feature game 250 and determine if the player is a qualified player based on the set of qualification criteria and the associated player criteria.

For example, in one embodiment, the system controller 200 may receive a request from a player to play the bonus feature game 250. The request may be received from a corresponding gaming device 12 being played by the player and/or a player tracking device 46 being operated by the player. The request may also include a unique player identification such as, for example, a player card inserted into the player tracking device 46 and/or a unique personal identification number input into the associated gaming device 12 and/or player tracking device 46 by the player, and/or any suitable identification that may be associated with the player. Upon receiving the request from the player including the unique player identification, the player qualification unit 270 transmits a request to the player tracking system 10 to determine a player tracking account 209 being stored in the database 205 and being associated with the unique player identification. The player qualification unit 270 retrieves the player criteria contained in the corresponding player tracking account and determine if the associated player is a qualified player that is eligible to participate in the bonus feature game 250 based on the qualification criteria and the retrieve player criteria. For example, in one embodiment, the player qualification unit 270 may determine the player to be a qualified player if the associated player criteria matches the qualification criteria. The qualification criteria may include any suitable criteria including, but not limited to, duration of game play, player rating, amount of wager, average wager, average game play, average non-gaming purchase, time of day, and/or any suitable criteria that may be associated with one or more players.

In one embodiment, the bonus feature game 250 may be associated with a predefined set of qualification criteria. In another embodiment, prior to the initiating the bonus feature game 250, the system controller 200 may display a player qualification criteria screen (not shown) to allow a system user such as, for example a casino operator, to establish the set of qualification criteria that may be used with the bonus feature game 250. In another embodiment, upon initiating the bonus feature game 250, the player qualification unit 270 may determine each player account that includes player criteria that matches the set of qualification criteria and send a notification message to each player to notify the player of the bonus feature game 250. In addition, the player qualification unit 270 may identify each gaming device 12 and/or player tracking device 46 currently being played and/or operated by a qualified player upon initiating the bonus feature game 250 and automatically display the bonus feature game 250 on each of the corresponding gaming devices 12 and/or player tracking devices 46.

In the illustrated embodiment, the symbol selection unit 272 displays the bonus feature game 250 including a plurality of bonus game symbols 266 that are included in a predefined set 274 of bonus game symbols 266. In the illustrated embodiment, the symbol selection unit 272 allows each of the qualified players to select a bonus game symbol 266 and associates the selected bonus game symbol 266 with the corresponding qualified player. In one embodiment, the symbol selection unit 272 displays a limited number of bonus game symbols 266 and allows each bonus game symbol 266 to be selected by one or more qualified players. In addition, each qualified player may select only one bonus game symbol 266. In another embodiment, the symbol selection unit 272 may randomly select a bonus game symbol 266 and associate the randomly selected bonus game symbol 266 with one or more qualified players. In addition, the symbol selection unit 272 may allow a qualified player to request a random selection of the associated bonus game symbol 266.

In one embodiment, the bonus feature game 250 may include one or more elimination rounds in which a number of bonus game symbols are selected and assigned to a subsequent elimination round. During each subsequent elimination round, the number of bonus game symbols 266 remaining in the bonus feature game 250 is reduced. For example, the bonus feature game 250 may be initiated with a first number of bonus game symbols 266. During a first elimination round, the symbol selection unit 272 selects a second number of bonus game symbols 266 for use in a subsequent round that is less than the first number of bonus game symbols 266. In addition, during a final game round, the symbol selection unit 272 selects a winning game symbol 268 from a group of remaining symbols and provides an award to each qualified player associated with the winning game symbol 268.

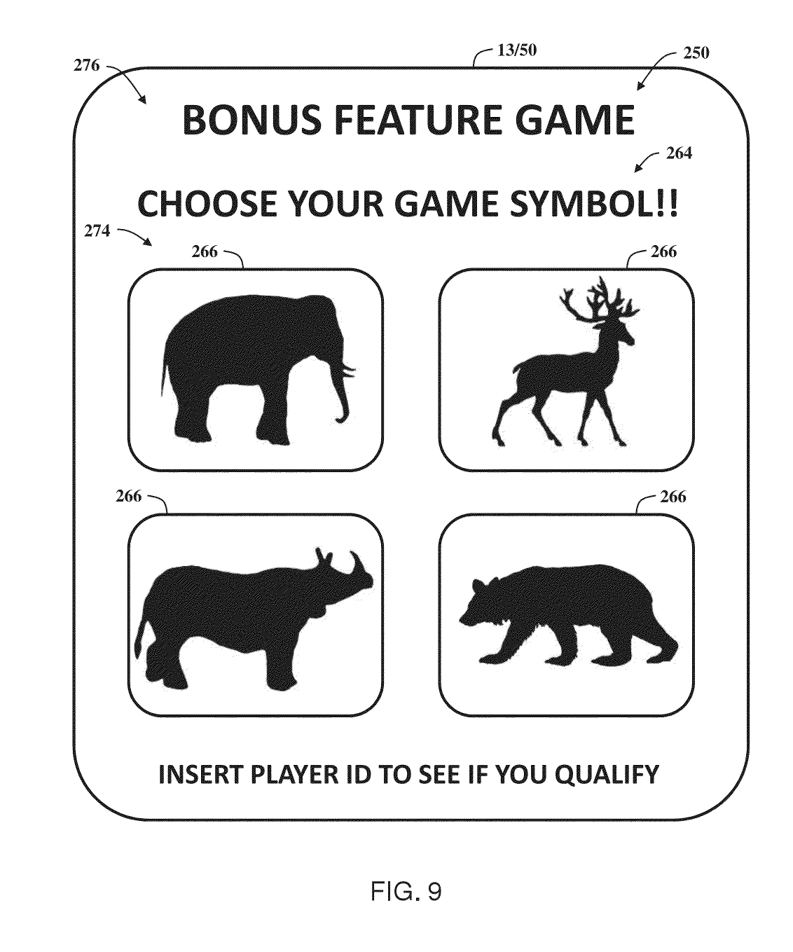

FIG. 8 is a flowchart of a method 300 that may be used with the system 2 for providing an award to a plurality of players. The method 300 includes a plurality of steps. Each method step may be performed independently of, or in combination with, other method steps. Portions of the method 300 may be performed by any one of, or any combination of, the components of the system 2 including the system controller 201, one or more gaming devices 12, and/or one or more player tracking devices 46. FIGS. 9 and 10 are exemplary entertaining graphical displays of the bonus game screen 264 including the bonus feature game 250 that may be displayed by the system 2.

In the illustrated embodiment, in method step 302, the system controller 200 displays the bonus feature game 250 on a plurality of gaming devices 12. In one embodiment, the system controller 200 displays the bonus feature game 250 including an elimination game that includes a plurality of a bonus game symbols 266 and a winning game symbol 268 that is selected from the plurality of bonus game symbols 266. However, it should be noted that the bonus feature game 250 may be any type of game upon which a player may be provided an award including, but not limited to a slot game, a maze game, a lottery-type game, a keno game, a blackjack game, a video poker game, or any type of game that enables the system controller 200 to function as described herein. In the illustrated embodiment, the system controller 200 detects a triggering condition and responsively initiates the bonus feature game 250 upon detecting the triggering condition. The triggering condition may include, but is not limited to, a predefined day and/or time, an amount of wagers received by a set of gaming devices, an amount of purchase made by one or more patrons, an amount of time spent at one or more gaming devices by one or more players, and/or any suitable triggering condition that may be used to initiate the bonus feature game 250. In one embodiment, the system controller 200 may initiate the bonus feature game 250 in response to a request received from a system user such as, for example, a casino employee.

In one embodiment, the system controller 200 may display the bonus feature game 250 on each of the gaming devices 12 included in the system 2. In another embodiment, the system controller 200 may display the bonus feature game 250 on a set of gaming devices 12. The set of gaming devices 12 may include a group of predefined gaming devices 12, such as for example, gaming machines located within a predefined area of a casino floor. In addition, the system controller 200 may display the bonus feature game 250 on a set of gaming devices that are each associated with a qualified player. In one embodiment, the system controller 200 may allow the system user to select a group of gaming devices 12 and display the bonus feature game 250 on each of the selected group of gaming devices 12.

In method step 304, the system controller 200 receives a request to play the bonus feature game 250 from a player via a corresponding gaming device 12. In one embodiment, the system controller 200 displays a notification message on one or more gaming devices 12 notifying the players that the bonus feature game 250 is being initiated and requesting the players to participate in the bonus feature game 250. In addition, the system controller 200 may display the notification message on each of the gaming devices 12 and/or display the notification message on a predefined set of display devices. In the illustrated embodiment, the system controller 200 receives a request from one or more players to participate in the bonus feature game 250 via a corresponding gaming device 12. In addition, the system controller 200 may receive the player's request to participate including a unique player identification associate with the corresponding player. For example, in one embodiment, the player may transmit the unique player identification via a gaming device 12 to request participation in the bonus feature game 250.

In method step 306, the system controller 200 determines if the player is a qualified player that is eligible to participate in the bonus feature game 250. If the system controller 200 determines the player to be a qualified player, the system controller 200 displays the bonus feature game 250 on the corresponding gaming device 12. If the system controller 200 determines that the player is not a qualified player, the system controller 200 does not display the bonus feature game 250 to the player and returns the gaming device 12 to a previous operating status, such as displaying a main game 80. In the illustrated embodiment, the system controller 200 generates the bonus feature game 250 including a set of qualification criteria that is indicative of a qualified player and determines if the player is a qualified player based on the set of qualification criteria. For example, the set of qualification criteria may include, but is not limited to, duration of game play, player rating, amount of wager, average wager, average game play, average non-gaming purchase, time of day, and/or any suitable criteria that may be associated with one or more players.

In one embodiment, the system controller 200 allows a system user to establish a unique set of qualification criteria for each of a plurality of bonus feature games 250. In addition, the system controller 200 may allow the system user to change and/or modify a corresponding set of qualification criteria at any time prior to initiating a bonus feature game 250. The system controller 200 may also determine a player criteria associated with the corresponding player and determine if the player is a qualified player based on the associated player criteria and the set of qualification criteria. For example, in one embodiment, the system controller 200 may receive a player's request to participate in the bonus feature game 250 including an associated unique player identification and determine a player account associated with the player as a function of the received unique identification. In addition, the system controller 200 may retrieve the associated player account from the database 205, determine the player criteria associated with the retrieved player account, and determine if the player is a qualified player based on the associated player criteria. Moreover, the system controller 200 may determine the player to be a qualified player if the associated player criteria included in the corresponding player account matches the bonus feature game qualification criteria, and responsively display the bonus feature game 250 on the corresponding gaming device. In the illustrated embodiment, the system controller 200 allows a plurality of qualified players to participate in the bonus feature game 250. Moreover, the system controller 200 may receive a request from a plurality of players via corresponding gaming devices 12, determine if each player is a qualified player, and allow each of the qualified players to play the bonus feature game 250.

In one embodiment, the system controller 200 may establish a bonus feature game qualification criteria including a predefined response time period and determine a player to be a qualified player if a response is received from the player within the predefined response time period. In addition, the system controller 200 may initiate a round of the bonus feature game 250 including those qualified players that have responded within the predefined response period. In one embodiment, the system controller 200 may establish the qualification criteria including a predefined number of qualified players, and initiate a round of the bonus feature game 250 when the predefined number of qualified players have responded.

In method step 308, the system controller 200 selects a bonus game symbol 266 from a predefined set 274 of bonus game symbols 266 and associates the selected bonus game symbols 266 with each qualified player for use during the bonus feature game 250. In the illustrated embodiment, the system controller 200 selects a bonus game symbol 266 for each of the qualified players and associates the selected bonus game symbols 266 with each corresponding qualified player. In one embodiment, the system controller 200 may display a symbol selection screen 276 on each corresponding gaming device 12 and allow each qualified player to select a bonus game symbol 266 from the predefined set of bonus game symbols 266. In another embodiment, the system controller 200 may randomly select a bonus game symbol 266 for each of the qualified players. In addition, the system controller 200 may allow one or more qualified players to select an associated bonus game symbol 266 and randomly select a bonus game symbol 266 for each remaining qualified player. For example, in one embodiment, the system controller 200 may require each qualified player to select an associated bonus game symbol 266 within a predefined period of time. Upon the expiration of the predefined period of time, the system controller 200 may randomly select a symbol for each of the remaining qualified players who have not selected an associated bonus game symbol 266. In another embodiment, the system controller 200 may determine a plurality of groups of gaming devices 12, randomly select a bonus game symbol 266 for each of the groups of gaming devices 12 and associate the selected bonus symbol 266 with each qualified player associated with the corresponding group of gaming devices 12.

In one embodiment, the system controller 200 may determine a selection probability associated with each bonus game symbol 266 and randomly select a bonus game symbol 266 for one or more qualified players as a function of the associated selection probabilities. In addition, the system controller 200 may determine the corresponding selection probabilities as a function of a player rating associated with a qualified player. For example, the selection probabilities associated with each bonus game symbol 266 may be provided as in the following chart. The following chart is provided for illustration only and does not limit the scope of the present invention.

Probability of Selecting a Game Symbol

| | |
|---|---|
| Player | Bonus Game Symbol |

| Rating | A | B | C | D |
|---|---|---|---|---|
| High | 5% | 15% | 30% | 50% |
| Medium | 10% | 20% | 30% | 40% |
| Low | 30% | 40% | 15% | 15% |

The first column represents the player ratings associated with the qualified players. The second, third, fourth, and fifth columns represents the selection probabilities associated with a plurality of bonus game symbols 266 such as, for example a symbol “A”, a symbol “B”, a symbol “C”, and a symbol “D”, respectively. In one embodiment, the system controller 200 may determine a player rating associated with a qualified player, determine the selection probabilities associated with each of the bonus game symbols 266 as a function of the player rating, and randomly select a bonus game symbol 266 associated with the qualified player as a function of the corresponding player rating and associated selection probabilities.

In method step 310, the system controller 200 conducts one or more elimination rounds associated with bonus feature game 250. Moreover, the system controller 200 may display an elimination screen 278 on each corresponding gaming device 12 that displays the results of each elimination round. In one embodiment, the bonus feature game 250 may include a predefined number of elimination rounds. In another embodiment, the system controller 200 may randomly select a number of elimination rounds being conducted with the bonus feature game 250. Moreover, the system controller 200 may allow a system user to select a number of elimination rounds included in the bonus feature game 250. During each elimination round, the system controller 200 randomly selects one or more bonus game symbols 266 from a participating group of bonus game symbols 266, and include the selected bonus game symbols 266 in a group of remaining bonus game symbols 266 for use in a subsequent elimination round and/or a final round. In addition, the system controller 200 may display a video movie and/or image of a competition between two or more participating bonus game symbols 266 to display the results of the elimination round in an entertaining display to the players. Moreover, in one embodiment, the system controller 200 may conduct an elimination round including randomly selecting a group of remaining bonus game symbols 266 from the predefined set of bonus game symbols, in which the group of remaining bonus game symbols 266 includes a fewer number of symbols than a number of symbols included in the predefined set of bonus game symbols. In addition, in one embodiment, the system controller 200 may conduct a plurality of elimination rounds and, for each elimination round, select a current group of remaining bonus game symbols 266 from a previous group bonus game symbols 266 associated with a previous elimination round, with the current group having fewer symbols than the previous group.

For example, in one embodiment, the system controller 200 may conduct a first elimination round 280 including establishing a participating group 282 of bonus game symbols 266 in which each of the bonus game symbols 266 are associated with one or more qualified players. During the first elimination round 280, the system controller 200 selects one or more symbols from the participating group 282 to be included in a remaining group 284 of bonus game symbol 266 that are assigned to a second elimination round 286. During each elimination round, the number of bonus game symbols 266 selected for each remaining group 284 of symbols is less than the number of symbols participating in the previous round. In one embodiment, the system controller 200 may randomly select the number of participating symbols associated with each elimination round, e.g. the number of bonus game symbols 266 that will be selected for a subsequent elimination round. In another embodiment, the system controller 200 may allow a system user to select the number of remaining bonus game symbols 266 for each elimination round.

In one embodiment, during each elimination round, the system controller 200 may determine a selection probability associated with each participating bonus game symbol 266, and randomly select the remaining group 284 of symbols as a function of each corresponding selection probability. In one embodiment, each bonus game symbol 266 may include a predefined selection probability that is used during each elimination round. In another embodiment, each bonus game symbol 266 may include a selection probability associated with each elimination round. For example, the selection probability associated with each bonus game symbol 266 may be provided as in the following chart. The following chart is provided for illustration only and does not limit the scope of the present invention.

Probability of Selecting a Game Symbol

Bonus Game Symbol

| Game Round | A | B | C | D |
|---|---|---|---|---|
| Elimination | 10% | 20% | 40% | 50% |
| Round 1 | | | | |
| Elimination | 15% | 50% | 30% | 50% |
| Round 2 | | | | |
| Final | 20% | 40% | 20% | 50% |

The first column represents the number of elimination rounds associated with bonus feature game 250. The second, third, fourth, and fifth columns represents the selection probabilities associated with each bonus game symbol 266 such as, for example symbol “A”, symbol “B”, symbol “C”, and symbol “D”, respectively. During each elimination round, the system controller 200 determines the current elimination round, determines each bonus game symbol 266 participating in the elimination round, and determines the selection probability associated with each participating bonus game symbol 266. For example, bonus symbol “A” has a 10% selection probability during the first elimination round, a 15% selection probability during the second elimination round, and a 20% selection probability during a final elimination round.

In another embodiment, the system controller 200 may adjust a selection probability associated with each bonus game symbol 266 included in the group of remaining bonus game symbols 266 participating in a current elimination round based in the number of symbols included in the current elimination round, and randomly select the bonus game symbols 266 as a function of adjusted selection probabilities.

In method step 312, the system controller 200 conducts a final elimination round 288 including selecting a winning bonus game symbol 268 from a remaining group 284 of bonus game symbols 266. In one embodiment, the system controller 200 may determine a selection probability associated with each of the bonus game symbols 266 included in the remaining group 284 and randomly select the winning bonus game symbol 268 as a function of the corresponding selection probabilities. In addition, the system controller 200 may adjust a selection probability associated with each bonus game symbol 266 included in the remaining group 284 of bonus game symbols 266 and randomly select the winning bonus game symbol 268 as a function of adjusted selection probabilities.

In one embodiment, the system controller 200 may initiate the bonus feature game 250 including a single elimination round and conduct the final round including randomly selecting the winning bonus game symbol 268 from the predefined set of bonus game symbols 266.

In method step 314, the system controller 200 identifies each winning qualified player associated with the winning bonus game symbol 268 and determines a number of winning qualified players. In one embodiment, the system controller 200 determines each qualified player that has selected the winning bonus symbol 268. In another embodiment, the system controller 200 determines each qualified player associated with a gaming device 12 that is associated with the winning bonus game symbol 268.

In method step 316, the system controller 200 provides a bonus award to each winning qualified player. In one embodiment, the bonus award may include a predefined award that is provided to each of the winning qualified players. In another embodiment, the system controller 200 may determine the number of winning qualified players and split the bonus award among each of the number of winning qualified players. For example, the bonus award may include an amount of incentive points. The system controller 200 may determine the number of winning qualified players and divide the amount of incentive points based on the number of winning qualified players. In another embodiment, the system controller 200 may provide a predefined amount of incentive points to each winning qualified player. Moreover, the system controller 200 may award an amount of incentive points to each winning qualified player based on an associated player rating. For example, a higher rated player may receive a larger amount of incentive points than a lower rated player.

Exemplary embodiments of a gaming device, a gaming system, and a method of providing an award to a plurality of players are described above in detail. The gaming device, system, and method are not limited to the specific embodiments described herein, but rather, components of the gaming device and/or system and/or steps of the method may be utilized independently and separately from other components and/or steps described herein. For example, the gaming device may also be used in combination with other gaming systems and methods, and is not limited to practice with only the gaming machine as described herein. Rather, an exemplary embodiment can be implemented and utilized in connection with many other gaming system applications.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A system for providing an award to a plurality of players, comprising:
a plurality of gaming devices, each of the gaming devices including a display device; and
a system controller coupled to each of the gaming devices, the system controller configured to:
initiate a bonus game and display the bonus game on a set of gaming devices, each gaming device included in the set of gaming devices being associated with a qualified player, the bonus game including a predefined set of bonus game symbols;
select a bonus game symbol for each qualified player from the predefined set of bonus game symbols and associate each selected bonus game symbol with the corresponding qualified player;
randomly select a winning bonus game symbol from the predefined set of bonus game symbols;
determine a number of winning qualified players associated with the winning bonus game symbol; and
provide a bonus award to each of the winning qualified players.

2. A system in accordance with claim 1, the system controller configured to:
allow each of the qualified players to select the associated bonus game symbol from the predefined set of bonus game symbols.

3. A system in accordance with claim 1, the system controller configured to:
conduct an elimination round associated with bonus game including randomly selecting a group of remaining bonus game symbols from the predefined set of bonus game symbols, the group of remaining bonus game symbols including a fewer number of symbols than a number of symbols included in the predefined set of bonus game symbols; and
conduct a final round including randomly selecting the winning bonus game symbol from the group of remaining bonus game symbols.

4. A system in accordance with claim 3, the system controller configured to:
adjust a selection probability associated with each bonus game symbol included in the group of remaining bonus game symbols; and
randomly select the winning bonus game symbol as a function of adjusted selection probabilities.

5. A system in accordance with claim 3, the system controller configured to conduct a plurality of elimination rounds and, for each elimination round, select a current group of remaining bonus game symbols from a previous group of remaining bonus game symbols associated with a previous elimination round, the current group having fewer symbols than the previous group.

6. A system in accordance with claim 5, the system controller configured to randomly select a number of elimination rounds being conducted with the bonus game.

7. A system in accordance with claim 5, the system controller configured to allow a system user to select a number of elimination rounds included in the bonus game and the number of bonus symbols included in the predefined set of bonus symbols.

8. A system in accordance with claim 1, further comprising:
a database including a plurality of player accounts, each player account being associated with a corresponding player and including a plurality of associated player criteria, the system controller configured to:
generate the bonus game including a set of qualification criteria indicative of the qualified player;
receive a request from a player to participate in the bonus game, the request being received via a corresponding gaming device and including a unique player identification;
determine a player account associated with the player as a function of the received unique identification; and
determine the player to be the qualified player if the player criteria included in the associated player account matches the qualification criteria, and responsively display the bonus feature game on the corresponding gaming device.

9. A method of providing an award to a plurality of players, including the steps of:
initiating, by a system controller, a bonus game being displayed on a plurality of gaming devices, each of the plurality of gaming devices being associated with a qualified player, the bonus game including a predefined set of bonus game symbols;
selecting a bonus game symbol for each qualified player from the predefined set of bonus game symbols and associating each selected bonus game symbol with the corresponding qualified player;
randomly selecting a winning bonus game symbol from the predefined set of bonus game symbols;
determining a number of winning qualified players associated with the winning bonus game symbol; and
providing a bonus award to each of the winning qualified players.

10. A method in accordance with claim 9, including the step of allowing each of the qualified players to select the associated bonus game symbol from the predefined set of bonus game symbols.

11. A method in accordance with claim 9, including the steps of:
conducting an elimination round associated with bonus game including randomly selecting a group of remaining bonus game symbols from the predefined set of bonus game symbols, the group of remaining bonus game symbols including a fewer number of symbols than a number of symbols included in the predefined set of bonus game symbols; and
conducting a final round including randomly selecting the winning bonus game symbol from the group of remaining bonus game symbols.

12. A method in accordance with claim 11, including the steps of:
adjusting a selection probability associated with each bonus game symbol included in the group of remaining bonus game symbols; and
randomly selecting the winning bonus game symbol as a function of adjusted selection probabilities.

13. A method in accordance with claim 11, including the step of conducting a plurality of elimination rounds and, for each elimination round, selecting a current group of remaining bonus game symbols from a previous group of remaining bonus game symbols associated with a previous elimination round, the current group having fewer symbols than the previous group.

14. A method in accordance with claim 13, including the step of randomly select a number of elimination rounds being conducted with the bonus game.

15. A method in accordance with claim 13, including the steps of allowing a system user to select a number of elimination rounds included in the bonus game and the number of bonus symbols included in the predefined set of bonus symbols.

16. A system in accordance with claim 9, including the steps of:
generating the bonus game including a set of qualification criteria indicative of the qualified player;
receiving a request from a player to participate in the bonus game, the request being received via a corresponding gaming device and including a unique player identification;
determining a player account associated with the player as a function of the received unique identification; and
determining the player to be the qualified player if the player criteria included in the associated player account matches the qualification criteria.

17. One or more non-transitory computer-readable storage media, having computer-executable instructions embodied thereon, wherein when executed by at least one processor, the computer-executable instructions cause the processor to:
initiate a bonus game and display the bonus game on a set of gaming devices, each gaming device included in the set of gaming devices being associated with a qualified player, the bonus game including a predefined set of bonus game symbols;
select a bonus game symbol for each qualified player from the predefined set of bonus game symbols and associate each selected bonus game symbol with the corresponding qualified player;
randomly select a winning bonus game symbol from the predefined set of bonus game symbols;
determine a number of winning qualified players associated with the winning bonus game symbol; and
provide a bonus award to each of the winning qualified players.

18. The one or more computer-readable storage media according to claim 17, the computer-executable instructions cause the processor to:
conduct an elimination round associated with bonus game including randomly selecting a group of remaining bonus game symbols from the predefined set of bonus game symbols, the group of remaining bonus game symbols including a fewer number of symbols than a number of symbols included in the predefined set of bonus game symbols; and
conduct a final round including randomly selecting the winning bonus game symbol from the group of remaining bonus game symbols.

19. The one or more computer-readable storage media according to claim 18, the computer-executable instructions cause the processor to conduct a plurality of elimination rounds and, for each elimination round, select a current group of remaining bonus game symbols from a previous group of remaining bonus game symbols associated with a previous elimination round, the current group having fewer symbols than the previous group.

20. The one or more computer-readable storage media according to claim 17, the computer-executable instructions cause the processor to:
generate the bonus game including a set of qualification criteria indicative of the qualified player;
receive a request from a player to participate in the bonus game, the request being received via a corresponding gaming device and including a unique player identification;
determine a player account associated with the player as a function of the received unique identification; and
determine the player to be the qualified player if the player criteria included in the associated player account matches the qualification criteria.
